(19) United States
(12) Patent Application Publication
(10) Pub. No.: US 2026/0259037 A1
(43) Pub. Date: Sep. 3, 2026

(54) Sensor For Sensing Fluid Flow, Touch and/or Vibration

(71) Applicant: Stellar Advanced Concepts Ltd, London (GB)

(72) Inventor: Michael Newsam, London (GB)

(73) Assignee: Stellar Advanced Concepts Ltd, London (GB)

(21) Appl. No.: 18/878,702

(22) PCT Filed: Jun. 22, 2023
(86) PCT No.: PCT/GB2023/051642

§ 371 Date: Dec. 24, 2024

(30) Foreign Application Priority Data
Jun. 24, 2022 (GB) 2209276.1

(51) Int. Cl. G01B 11/16; B63B 79/10; G01B 11/30; G01F 1/54; G01H 9/00; G01P 5/02; G01P 13/00

(52) U.S. Cl. CPC G01B 11/16; B63B 79/10; G01B 11/303; G01F 1/54; G01H 9/00; G01P 5/02; G01P 13/0013

(57) ABSTRACT

Certain examples of the present disclosure relate to a sensor (100) for sensing fluid flow, touch and/or vibration. The sensor comprises: a plurality of elongate shaft members (101) movably attached to a distortable surface (102) such that movement of one or more of the plurality of elongate shaft members distorts the surface; and means (103) configured to measure distortion of the distortable surface for determining movement of one or more of the plurality of elongate shaft members.

### TECHNOLOGICAL FIELD

Examples of the present disclosure relate to a sensor for sensing fluid flow, touch and/or vibration. Some examples, though without prejudice to the foregoing, relate to a submersible whisker/vibrissae-based tactile sensor.

### BACKGROUND

Conventional sensors, such as those for use in a fluid environment, are not always optimal. Typically, sensors for use in a fluid environment, e.g. for underwater surveillance, have been vision and sonar-based sensor systems. However, vision-based sensors may have a limited perceptible range due to the absorption and scattering of light particularly in underwater environments which can be muddy and cloudy. Also, an artificial source of light energy maybe required in order to use a vision-based underwater sensor due to the low level of natural illumination particularly in deep water. Similarly, the transmission of acoustic waves is required for a sonar system to estimate the location of an object. Since both techniques typically perform active sensing (emitting light or acoustic waves), the location of an emitter may be revealed, thereby reducing a level of stealth in surveillance applications. Also, such emission based active sensing can have increased energy consumption and sub-optimal energy efficiency. Finally, emissions from such active sensing systems (not least acoustic waves/sound) can be detrimental to marine animals.

In some circumstances it can be desirable to provide an improved sensor for sensing fluid flow, touch and/or vibration.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided a sensor for sensing fluid flow, touch and/or vibration, the sensor comprising:
a plurality of elongate shaft members movably attached to a distortable surface such that movement of one or more of the plurality of elongate shaft members distorts the surface; and
means configured to measure distortion of the distortable surface for determining movement of one or more of the plurality of elongate shaft members.

According to various, but not necessarily all, examples of the disclosure there is provided a system comprising the above-mentioned sensor, the system further comprising one or more of:
means for determining movement of one or more of the elongate shaft members based, at least in part, on one or more measurements of deformation of the deformable surface;
means for measuring fluid flow and/or vibration based, at least in part, on one or more measurements of deformation of the deformable surface; and
means for detecting an object via tactile sensing based, at least in part, on one or more measurements of deformation of the deformable surface.

According to various, but not necessarily all, examples of the disclosure there is provided a method comprising:
measuring distortion of a distortable surface of a sensor, wherein a plurality of elongate shaft members is movably attached to the distortable surface such that movement of one or more of the plurality of elongate shaft members distorts the surface; and
determining movement of one or more of the plurality of elongate shaft members based at least in part on the measured distortion of the distortable surface.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided a computer program for causing an apparatus to perform:
measuring distortion of a distortable surface of a sensor, wherein a plurality of elongate shaft members is movably attached to the distortable surface such that movement of one or more of the plurality of elongate shaft members distorts the surface; and
determining movement of one or more of the plurality of elongate shaft members based at least in part on the measured distortion of the distortable surface.

According to various, but not necessarily all, examples of the disclosure there is provided an apparatus comprising:
at least one processor; and
at least one memory including computer program code;
the at least one memory storing instructions that, when executed by the at least one processor, cause the apparatus at least to:
   measure distortion of a distortable surface of a sensor, wherein a plurality of elongate shaft members is movably attached to the distortable surface such that movement of one or more of the plurality of elongate shaft members distorts the surface; and
   determine movement of one or more of the plurality of elongate shaft members based at least in part on the measured distortion of the distortable surface.

According to various, but not necessarily all, examples of the disclosure there is provided a non-transitory computer readable medium encoded with instructions that, when performed by at least one processor, causes at least the following to be perform:
measuring distortion of a distortable surface of a sensor, wherein a plurality of elongate shaft members is movably attached to the distortable surface such that movement of one or more of the plurality of elongate shaft members distorts the surface; and
determining movement of one or more of the plurality of elongate shaft members based at least in part on the measured distortion of the distortable surface.

According to various, but not necessarily all, examples of the disclosure there is provided a method of providing and/or manufacturing an apparatus and/or system as described herein.

According to various, but not necessarily all, examples of the disclosure there is provided a method of using an apparatus and/or system as described herein.

In the “Detailed Description” section, various examples of the present disclosure are described that include features that can be features of any of the examples described in the foregoing portion of the ‘Brief Summary’ section. The description of a function should additionally be considered to also disclose any means suitable for performing that function. While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features may be performed in a method and/or by an apparatus, in any combination, as desired, and as appropriate.

### BRIEF DESCRIPTION OF THE DRAWINGS

Some examples will now be described with reference to the accompanying drawings in which:

FIGS. 1A and 1B schematically illustrate an example apparatus according to the present disclosure;

FIG. 2 schematically illustrates an example method according to the present disclosure;

FIGS. 3A and 3B schematically illustrate further example apparatuses according to the present disclosure;

FIG. 4 schematically illustrates another example apparatus according to the present disclosure;

FIGS. 5A to 5D schematically illustrate a further example apparatus according to the present disclosure;

FIG. 6 schematically illustrates another example apparatus according to the present disclosure;

FIG. 7 schematically illustrates another example apparatus according to the present disclosure;

FIG. 8 schematically illustrates yet another example apparatus according to the present disclosure; and

FIG. 9 schematically illustrates an example computer program according to the present disclosure.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

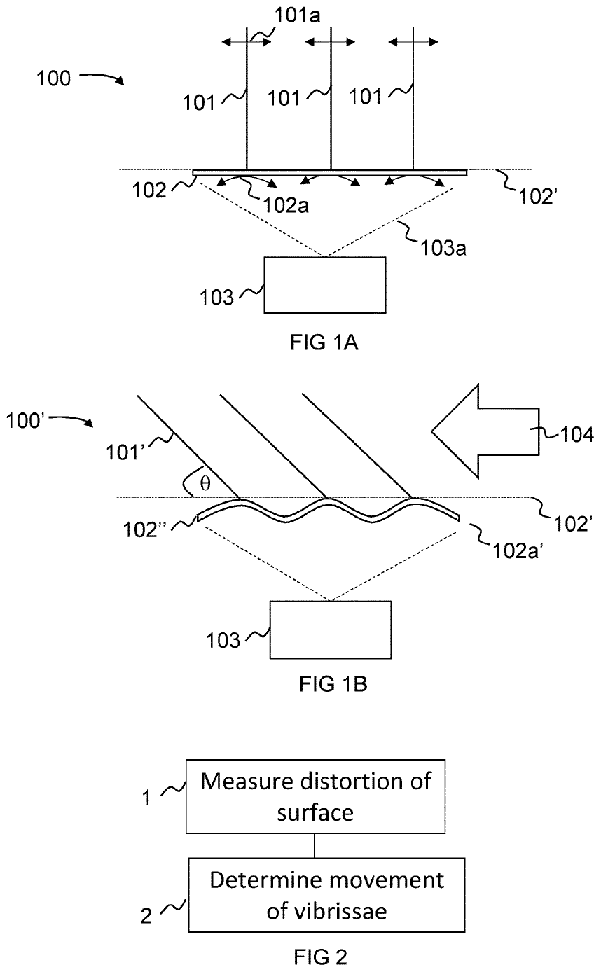

FIG. 1 schematically illustrates a sensor 100 for sensing fluid flow, touch and/or vibration. The sensor comprises a plurality of elongate shaft members/slender beams 101. Each of the plurality of elongate shaft members is attached, at a proximal end/root thereof, to a distortable surface 102 such that each elongate shaft member is mechanically coupled/fixed/physically secured/mounted to the distortable surface so that each elongate shaft member projects/extends outwardly from the distortable surface so as to be exposed to the environment/medium/object to be sensed.

The one or more of the plurality of elongate shaft members may be attached to the distortable surface in any suitable manner (e.g. affixed to, adhered to, fastened to, embedded in, integrally formed with . . . ). The one or more of the plurality of elongate shaft members and the distortable surface are configured such that movement (schematically represented by arrows 101a) of one or more of the plurality of elongate shaft members relative to the distortable surface distorts (schematically represented by arrows 102a) the distortable surface. In this regard, the one or more of the plurality of elongate shaft members may be substantially rigid, or semi rigid.

The distortable surface is configured such that its shape or form is able to be distorted as compared to a default/normal/non-distorted shape or form. In other words, the shape of the distortable surface can be deformed by movement (e.g. rotation, pivoting and/or translational movement) of the one or more of the plurality of elongate shaft members (not least a distal end/tip of the same) relative to the surface.

With the above configuration, the elongate shaft members are configured to be movably attached/mounted to the distortable surface such that movement of one or more of the plurality of elongate shaft members distorts the distortable surface. In such a manner, a distortion of the distortable surface is indicative of movement of one or more of the plurality of elongate shaft members. Hence, in examples of the disclosure, a determination of movement of one or more of the plurality of elongate shaft members can be based, at least in part, on a detection/determination/measurement of a distortion of the surface.

The sensor comprises means 103 for measuring (schematically represented by dotted lines 103a) distortion (schematically represented by arrows 102a) of the distortable surface. Based at least in part on one or more measurement of a distortion of the surface, a determination can be made of movement of one or more of the plurality of elongate shaft members.

As will be discussed further below, in some examples, the sensor provides a sensor signal/output (e.g. it generates sensor measurement data) that is based at least in part on a measured distortion/deformation of the distortable/deformable surface which is indicative of movement of one or more of the plurality of elongate shaft members. The sensor signal/output can thereby be indicative of external forces acting on the one or more of the plurality of elongate shaft members (e.g. fluid flow, touch and/or vibration) causing movement of the same.

In some examples, one or more of the plurality of elongate shaft members is one or more of:
a sensor element, such as a vibrissa or whisker of a vibrissae/whisker-based tactile sensor;
substantially or semi rigid (e.g. substantially or semi unable to bend or be forced out of shape, substantially inflexible);
substantially or semi resilient (e.g. substantially or semi able to recoil or spring back into shape/position after bending, stretching, or being compressed); and
substantially or semi flexible (e.g. substantially or semi capable of bending easily without breaking).

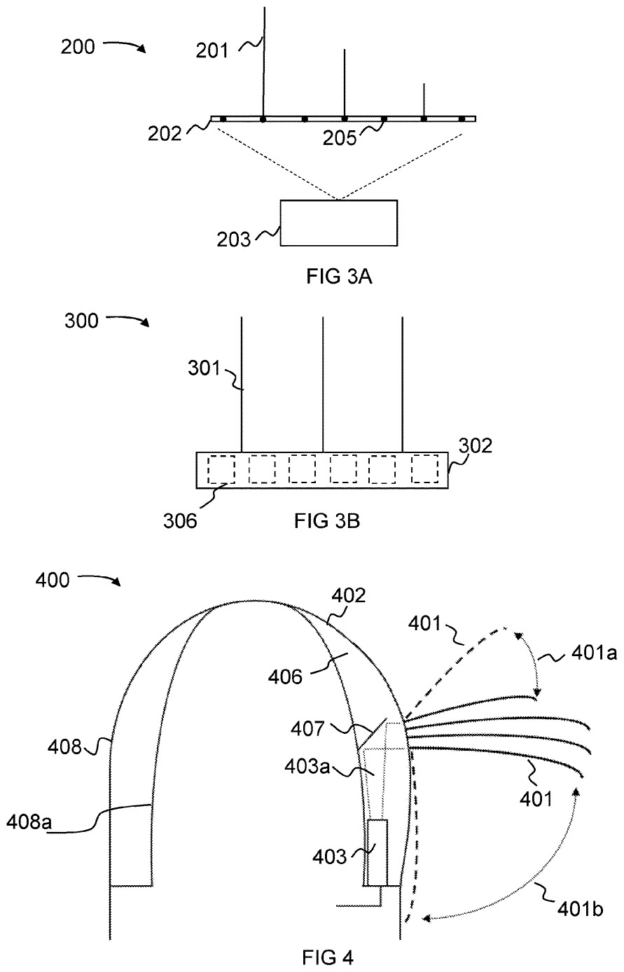

In some examples, some of the plurality of elongate shaft members may have differing physical characteristics as compared to others of the plurality of elongate shaft members, not least for example differing: lengths (e.g. as shown in FIG. 3A), resonant frequencies, rigidity, resilience, curvature, cross-sectional shape, flexibility, and density. In some examples, this may be achieved by using materials of varying internal structure or material density along the length of each elongate shaft member.

Advantageously, this may improve the sensitivity of the sensor to different frequencies or sequences of pressure changes or vibrations. It may help ensure that not all of the elongate shaft members sympathetically harmonise with an external force/stimulus to be measured, e.g. a particular vibration frequency in an environmental fluid in which the sensor is placed. This may thereby improve the sensor's sensitivity as well as its ability to detect and measure different vibrations or wake patterns.

In some examples, the distortable surface is a membrane, sheet-like member and/or a supporting surface that supports the one or more elongate shaft members attached thereto.

In some examples, at least a part of a hull or nose cone of a surface vessel or underwater vehicle could serve as the distortable surface/membrane, i.e. wherein such a part is configured to be flexible (not least for example by being thinner than normal). In some examples, distortion of the distortable surface could be measured/detected by one or more strain gauges.

In some examples, the distortable surface is one or more of:
substantially elastic (e.g. able to resume its normal shape spontaneously after being stretched or compressed),
substantially flexible (e.g. pliable/capable of bending easily without breaking) substantially deformable, and
substantially distendable (e.g. configured to able to swell or caused to swell by pressure [such as from an expandable/inflatable chamber/bladder] from inside the sensor).

In some examples, the distortable surface forms a part of an expandable/inflatable chamber/bladder, the inflation of which distorts the shape/curvature of the distortable surface and thereby moves the one or more elongate shaft members attached to the distortable surface. In such a manner, movement of the one or more elongate shaft members can be controlled, e.g. so as to re-orientate the one or more elongate shaft members. In some examples, the distortable surface forms a part of an external surface and/or housing for the sensor.

The elongate shaft members serve as sensing elements/receptors for the sensor that are responsive to a physical stimulus, namely an external force acting of the shaft members such as: mechanical stimulation, tactile stimulation, physical interaction with the environment, movement of a medium/fluid surrounding the shaft members (e.g. fluid flow) impinging on the shaft members, a touch of the shaft members and/or vibration of the shaft members. In such a manner, the plurality of elongate shaft members may act as vibrissae/whiskers for a vibrissae/whisker-based tactile sensor. Hereinafter, the elongate shaft members are referred to as vibrissae.

FIG. 1A shows the sensor in a default configuration of the sensor in a deployed mode, namely wherein the vibrissae extend substantially normal/perpendicularly to the distortable surface (i.e. the vibrissae are at 90° to a plane 102′ defined by the distortable surface in its default/non-distorted shape).

FIG. 1B shows the sensor 100′ in an in-use configuration of the sensor in-use, namely wherein the vibrissae 101′ are acted on by an external force (as schematically represented by arrow 104, e.g. a fluid flow over the surface of the sensor) which causes the vibrissae to move relative to the distortable surface 102″, namely to rotate/pivot about the base of the vibrissae (i.e. the vibrissae are at a shaft angle 0° to the plane 102′ defined by the distortable surface in its non-distorted shape). Since the vibrissae 101′ are securely attached/fixed to the distortable surface, such movement of the vibrissae 101′ causes the distortable surface to distort/warp (as schematically represented by 102a′). Such a distortion is measured by the means 103 for measuring distortion of the distortable surface. The measured distortion can then be used for inferring/determining movement (or estimating movement) of one or more of the vibrissae, which itself can be used to infer/determine/estimate characteristics of the external force. For example, based on a measurement of the distortion of the distortable surface, a shaft angle (e.g. rotation/pivot angle) 0° could be determined for one or more vibrissae, and based on this a measurement of the externals force (e.g. fluid flow velocity) could be determined/estimated.

In examples of the disclosure, measured distortions of the distortable surface can be interpreted by a machine learning algorithm or neural network trained to assess the dynamic position of the vibrissae. This may thereby allow interpretation of environmental stimuli acting upon the vibrissae (such as determining a wake generated by an object in a fluid within which the sensor is disposed). Examples of the disclosure may thereby allow detection, identification and determination of a relative position of a wake generating object. Examples of the disclosure may also enable assessing attributes of wake generating objects (such as size, velocity, propulsion type of bodies moving in a fluid).

Advantageously, in various examples of the present disclosure, a single means for measuring distortion of the distortable surface can be used (e.g. camera) that can detect distortion on the distortable surface caused by plural vibrissae and, based on the same, movement of plural vibrissae can be determined. In other words, instead of requiring an individual sensor for measuring movement of each individual vibrissa, movement of plural individual vibrissa can be determined via a single sensor (e.g. camera) for sensing distortion of the distortable surface. Hence, instead of requiring a one-to-one ratio of movement sensors to vibrissae, examples of the disclosure permit a one-to-many ratio of movement sensors to vibrissae, which facilitates the use of more numerous vibrissae in the sensor.

FIG. 2 schematically illustrates a method according to the present disclosure. The blocks illustrated in FIG. 2 can represent actions in a method, functionality performed by an apparatus, and/or sections of instructions/code in the computer program. It will be understood that each block and combinations of blocks illustrated in FIG. 2, as well as the further functions described below, can be implemented by various means, such as hardware, firmware, and/or software including one or more computer program instructions. In block 1, one or more measurements of one or more distortions of the distortable surface are made. In block 2, a determination of movement one or more of the vibrissae is made based at least in part on the measured one or more distortions of the distortable surface. The method may further comprise generating sensor measurement data based at least in part on inputting data indicative of the measured distortion of the distortable surface into a model; wherein the model is configured to receive, as an input, one or more measurements of distortions of the distortable surface and output sensor measurement data for the same. The model may be configured to correlate and/or perform a mapping of the measurements of distortions of the distortable surface to sensor measurement data. The model may be generated via a machine learning system that has been trained, on a training dataset comprising a plurality of measurements of distortions of the distortable surface whose respective sensor measurement data have been pre-determined, so as to determine one or more correlations between distortions of the distortable surface and sensor measurement data.

The sensor measurement data may be indicative of a measurement or detection of at least one of:
movement of one or more of the vibrissae,
a fluid flow,
a touch,
a vibration,
a wake, and/or
an object.

It is to be appreciated that the training phase for the model, which may be highly computationally intensive, may be separate from the actual use of the resultant generated/trained model. The training and generation of the model may occur at a server. The trained model may be used at the server, or provided/transmitted to another server, or even a client device (such as a controller for the sensor), for use thereon in the determination of sensor measurement data. The trained model may be included in the sensor controller (e.g. at compile/build time) or the trained model may be transmitted to the sensor controller using an appropriate (wired or wireless) communication channel. By providing the trained model to the sensor, it can generate, for itself, sensor measurement data.

The component blocks of FIG. 2, and method steps mentioned above, are functional and the functions described can be performed by a single physical entity (such as is described with reference to FIG. 8). The functions described can also be implemented by a computer program (such as is described with reference to FIG. 9). In some examples, one or more of the above-described actions can performed by/at a plurality of entities. For instance, certain data processing steps may occur remote of the sensor and remote of a device/vehicle to which the sensor is attached.

FIG. 3A schematically illustrates an example of a sensor 200, similar to that described above, but wherein the vibrissae 201 have differing physical characteristics; namely in this example, the vibrissae are not all of the same uniform length but are of differing lengths. Also, the distortable surface 202 is provided with fiducial markers 205 on its underside for facilitating the measuring of distortions by the distortion measuring means 203, which in this example is a camera.

FIG. 3B schematically illustrates an example of a sensor 300, similar to that described above with respect to sensor 100, further comprising means for moving one or more of the vibrissae (i.e. to actively move/control movement of the vibrissae, as compared to the ‘passive’ movement of the vibrissae caused by being acted upon by an external force such as fluid flow or touch be an external object).

In this example, the means for moving (e.g. rotational/pivoting movement or translational movement) one or more of the vibrissae takes the form of a plurality of expandable chambers 306. The plurality of expandable chambers 306 are configured such that expansion of one or more of the expandable chambers causes distortion/deformation of the distortable surface, e.g. adjusting a shape/curvature of the distortable surface. Since the vibrissae are securely attached and fixed to the distortable surface, such distortion of the distortable surface causes movement of one or more of the vibrissae.

In the example shown, the expandable chambers 306 are provided within the distortable surface 302 (e.g. embedded within, or integral to the distortable surface 302). In other examples, the expandable chambers 306 may be provided proximal to the distortable surface 302 (e.g. at a underside or internal side of the distortable surface 302). The expandable chambers 306 may be provided proximal to a base/root of each of one or more of the vibrissae. In some examples, the distortable surface 302 forms a part of one or more of the expandable chambers 306. For instance, the distortable surface 302 defines at least a part of an expandable wall of and expandable chamber which can be expanded/inflated/distended upon introduction of a fluid into the expandable chamber.

The expandable chambers may be individually controllable so as to selectively individually expand which thereby enables selectively controllable distortion of the distortable surface and which thereby enables selectively controllable movement of the vibrissae.

The expandable chambers may be inflated/distended by introducing a fluid (e.g. not least: oil, water or pressurised gas) into the chambers, thereby adjusting the shape of the distortable surface causing movement of the vibrissae attached to the distortable surface.

The expandable chambers can be configured, not least in the size and placement of the chambers internal/proximal to the surface and with respect to the vibrissae to enable positional or angular arrangement of each vibrissa to be controlled. In some examples, the distendable surface is be able to distended whilst not changing the density (buoyancy) of the sensor and/or device/vehicle comprising the sensor, (for example in conjunction with chambers within a sensor housing but external to the surface).

The means for moving the one or more of the vibrissae may thereby: control a position of one or more of the vibrissae relative to the distortable surface;
adjust an angle/orientation at which the one or more of the vibrissae extend from the distortable surface (i.e. adjust a shaft angle);
retract the one or more (or the majority of or all) of the vibrissae (e.g. adjust the shaft angle to a retracted or stowed configuration/mode/angle, such as a shaft angle of substantially 0°, <15°, <30°, or <45° so that the vibrissae may lie substantially flat/parallel to the distortable surface and/or be arranged in a streamlined/low drag configuration); advantageously, this may be done for the purpose of protection of the vibrissae during storage and transportation of the sensor and/or during launching or docking of a device (such as an underwater vehicle) comprising the sensor; and
deploy the one or more (or the majority of or all) of the vibrissae (e.g. adjust the angle to a deployed/ready-for-use configuration/mode angle, such as substantially normal/perpendicular, i.e. having an angle of 90°) so that the vibrissae may be orientated substantially normal/perpendicular to the distortable surface.

The means for moving the one or more of the vibrissae may thereby actively move the vibrissae relative to the deformable surface by using mechanical means (such as by varying the pressure behind/within the distortable surface, or applying a force to the edge of the surface). Advantageously, this may enable an optimisation of the sensor by reconfiguring the position/orientation of the vibrissae. This may, for example, improve the sensing of pressure fluctuations in a fluid flow, for instance by semi-retracting the vibrissae for measuring (fast) fluid flow above a threshold value, and fully deploying the vibrissae i.e., for measuring (slow) fluid flow below a threshold value.

In the example shown, an expandable chamber is provided proximal to a base/root of each of one or more of the vibrissae. In other examples, one or more expandable chambers may be provided for one or more vibrissae. In some examples, a single expandable chamber is provided (such as in FIG. 4).

In some examples (not shown), the sensor further comprises at least one rigid protruding member which is disposed adjacent to one or more of the vibrissae. The at least one protruding member is fixed to the sensor such that (unlike the vibrissae movably mounted to the distortable surface) the at least one protruding member is not movably mounted to the distortable surface but is instead substantively immovable with respect to the sensor and/or distortable surface. The rigid protruding member does not seek to serve as a sensing element (such as the vibrissae). Instead, one or more (non-sensing) protruding members may be positioned in front of one or more vibrissa (i.e. disposed “upstream” relative to the vibrissae) in order to act as a baffling member, for instance to alter/reduce a flow in a fluid (such as reduce its relative velocity or turbulence). This can help improve sensor measurements from the (downstream) sensing elements/vibrissae. This may help improve the interpretation of wake information in the fluid.

In some examples, an array of vibrissae is provided, for instance a two-dimensional array of vibrissae wherein the vibrissae are arranged to form a two-dimensional grid, not least for example such as a four by eight grid. This may enable the sensor to simultaneously provide a range of sample locations of, or points of contact with, the environment.

In some examples, the array of vibrissae may be a linear array, for example for placement along/embedded in a leading/trailing edge or surface such as on an aerofoil or hydrofoil. In such an example, a camera could ‘look down the line’ of the linear array of vibrissae e.g. at their roots.

In some examples, the sensor comprises means (such as means discussed above with respect to FIG. 3B) for moving one or more of vibrissae in one or more dimensions of the at least two-dimensional array of vibrissae. For example, with respect to FIG. 3B, the means for moving the vibrissae could pivot/rotate each vibrissa about its root in: a first dimension (i.e. pivot a direction to the left or right), and in a second dimension (i.e. pivot in a direction into or out of the page).

In some examples, the sensor is configured to be submersible, i.e. designed to operate in a liquid.

In some examples, the means 103 configured to measure distortion of the distortable surface is internal of the sensor, e.g. disposed within a housing (not shown) of the sensor. In some examples, the means 103 configured to measure distortion of the distortable surface comprises means for capturing an image of the distortable surface (e.g. an image capturing device, image sensor, CCD and/or camera) which captures an image (e.g. a multidimensional image such as a 2D image or 3D image) of an under/internally facing side of the distortable surface (with the one or more vibrissae extending from the upper/externally facing side of the distortable surface). In some examples, a measurement/detection and/or determination of distortion of the distortable surface is based, at least in part on a captured image of the distortable surface, e.g. based on image processing of the same. In this regard, image features, patterns, and characteristics of a captured image of the distortable surface may be associated with one or more differing types and extents of distortions of the distortable surface so as to classify and quantity distortions of the distortable surface. For example, image features, patterns, and characteristics may be pre-associated with particular types and extent of distortions. In this regard, a model, function or mapping may be provided that associates/correlates particular image features, patterns, and characteristics to particular types and extent of distortions. A computer program or algorithm may be provided that is configured to use such pre-determined associations (e.g. stored in a database or another data structure) to determine (e.g. via a look up table/a model/a function) a particular type and extent of distortions and thereby measure the distortion of the distortable surface.

In some examples, the means for measuring a distortion comprises inputting one or more captured images of the distortable surface into a model, wherein the model is configured to receive, as an input, an image and output sensor measurement data, namely an indication of a measurement of a distortion of the distortable surface. The model may be generated via a machine learning system that has been trained, on a training dataset comprising a plurality of images of the distortable surface whose distortion has been pre-determined, so as to determine one or more correlations between image features and distortions.

In some examples, in order to aid the measurement of distortion of the distortable surface, the surface is provided with one or more fiducial markers. For example, the imaged internal surface may have visual or physical markings (such as reference points, and/or grid lines) to aid observation and categorisation of distortions.

In some examples, the means 103 configured to measure distortion of the distortable surface comprises one or more strain gauges.

In some examples, a determination is made as to movement of one or more of the vibrissae based, at least in part, on the measured distortion of the distortable surface. Such a determination may occur either in the sensor itself (e.g. in control circuitry of the sensor), of it may occur remote of the sensor (e.g. at a separate processing device or server, based on sensor measurements/data received from the sensor indicative of a measured distortion of the distortable surface). The determination may comprise inputting one or more distortion measurements into a model, wherein the model is configured to receive, as an input, one or more distortion measurements and output sensor measurement data in the form of an indication of movements of one or more of the vibrissae. The model may be generated via a machine learning system that has been trained, on a training dataset comprising a plurality of distortion measurements where the associated movements of one or more of the vibrissae that gives rise to such distortions has been pre-determined, so as to determine one or more correlations between distortion measurements and movements of one or more of the vibrissae.

In some examples, the above-mentioned model could be combined with the previously mentioned model, so that such a hybrid model can be used effectively to determine movements of one or more of the vibrissae based on captured images of the distortable surface.

Similarly, a further machine learnt trained model may be generated and separately applied or incorporated into the previously discussed models to determine sensor measurement data such as an indication of a:

fluid flow, touch, vibration, object detection and/or wake detection based on the: captured images, distortion measurements and/or determined vibrissae movements.

In some examples, one or more of the vibrissae are configured to be able to convey light therethrough (e.g. have a transparent/translucent core) and moreover are configured to modulate light conveyed therethrough responsive to the one or more of the vibrissae being bent. In this regard, the vibrissae may comprise an internal structure (such as Bragg gratings) that is configured to be capable of, in effect, conveying information of the shape (bending) of the vibrissa down through the core of the vibrissa itself (such as by detecting changes, via a fibre optic sensing system, in the light that is reflected/transmitted through the vibrissa).

In some examples, one or more of the vibrissae are configured to be able to convey pressure therethrough (e.g. have a fluid filled hollow core) that is configured to be capable of, in effect, conveying information of the shape (bending) of the vibrissa down through the core of the vibrissae itself (such as by detecting internal pressure changes in a fluid core generated by bending, via a pressure sensing system, in fluidic pressure transmitted through the vibrissa).

In some examples, the sensor comprises means for sensing electromagnetic radiation. In this regard, one or more of the vibrissae may be configured to sense electromagnetic radiation. For instance, the one or more of the vibrissae may comprise or be made from an electrically conductive material, such as a metal or other conductor, configured to act as an antenna for receiving and/or transmitting electromagnetic radiation. One or more of the vibrissae may contain a metallic wire which connects to embedded (flexible) metallic wiring in the distortable surface.

In some examples, the sensor comprises radio frequency circuitry, electrically connected to the vibrissae, for receiving and/or transmitting electromagnetic waves.

FIG. 4 schematically illustrates an example of a device 400 comprising a sensor similar to that described above with respect to sensor 100.

The sensor is a tactile vibrissae sensor/whisker sensor for sensing fluid flow that is provided in the device 400. The device in this example is a submersible device such as an unmanned submersible vehicle/Autonomous Underwater Vehicle “AUV”—a bow portion 408 of which is illustrated. As will be readily appreciated, examples of the disclosure can be applied to other types of devices and other types of underwater vehicles; and can be applied to, not least for example, a robotic arm.

The sensor comprises a plurality of vibrissae 401 (e.g. elongate sensing elements/whiskers), each having a first end (e.g. a proximal end/root) and a second end (e.g. distal end/tip). A distortable surface 402 defines a part of an external housing for the sensor. The distortable surface 402 also defines an interior region 406 of the sensor. A means for measuring surface distortion, namely an image capturing means 403 such as a camera or other optical sensor, is located within the housing/interior region. The vibrissae are mounted to the distortable surface such that the first end of the elongate member is securely attached to distortable surface 402 and the second end of the elongate member extends externally of the housing so as to be exposed to the external environment to be sensed. In the example shown, the root end portions of the vibrissae may extend into the interior region of the distortable surface such that the end portions of the root project from the inner side of the distortable surface so as to be visible on an interior side of the housing. In the particular example of FIG. 4, the righthand/starboard side of the bow portion 408 (comprising the distortable surface 402) is distendable, whereas the lefthand/port side of the bow portion is rigid. A pressure/inner hull 408a is provided internal of the bow portion/bow cover.

Although FIG. 4 shows only a sensor configuration (vibrissae array attached to a distortable surface with means for measuring surface distortion) provided on one side (a righthand side/starboard side) of the device, it is to be appreciated that one or more further sensor configurations could be provided on the device (not least on a lefthand side/port side of the device).

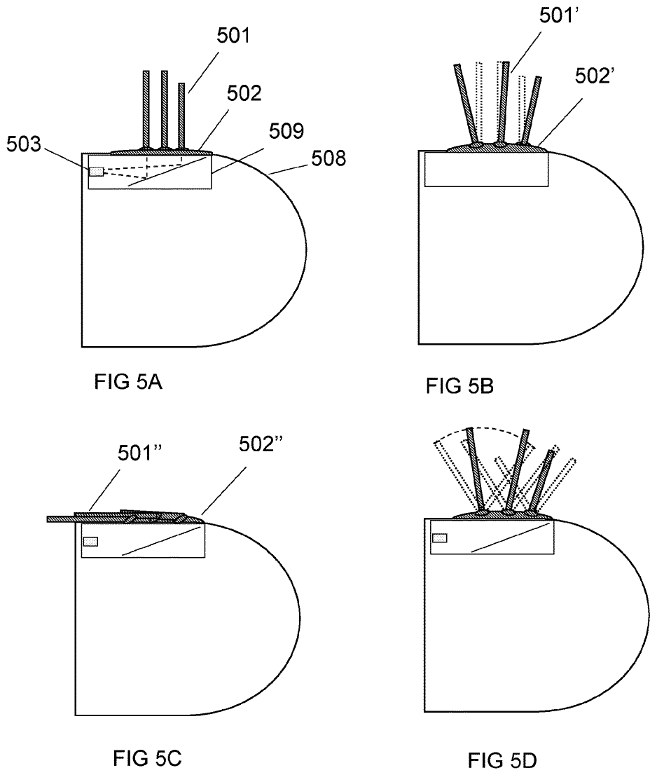

The mounting of the vibrissae to the distortable surface enables the vibrissae to be movable relative to the vibrissae (e.g. to pivot/change their position/orientation relative to the distortable surface) by virtue of such movement of the attached vibrissae distorting the distortable surface. As mentioned above with respect to FIG. 3B, movement of the vibrissae can be actively controlled. The vibrissae could be moved (schematically represented by arrow 401b) so as to be placed in a retracted/stowed/low drag configuration, wherein they lie substantially flat/parallel against the body (also as shown in FIG. 5C). Such a retracted/stowed/low drag configuration may be useful during storage and transportation of the device and/or during launching or docking of the device.

The image capturing means is configured to capture images of the internal side of the distortable surface (and capture images of each of the first ends extending into the interior region) for detecting movement (schematically represented by arrow 401a) of each vibrissa root end. A reflective surface, e.g. mirror, is used to direct light to the image capturing means. Advantageously, by redirecting the light, this may enable a more space efficient arrangement of components and enable a reduction in the dimensions, e.g. not least lateral dimensions/width, of the sensor.

In some examples, the image capturing means or camera system can interpret the root array as a pixel or as intensity. In some examples, the image capturing means or camera system is a binocular system and/or preceded by a filter which deflects optical information to confer directional information from the root array to the camera. In some examples, the underside/inner surface of the distortable surface is provided with a reflective coating and/or devices/light sources are provided to the root tips (for example IR) to enhance the optical sensing/measurement of the distortable surface.

In some examples, the measurement data (such as optical sensor data of the distortable surface) may be stored and/or processed in the sensor housing, or transferred into a body of the device/vehicle to which the sensor is attached by wire or wireless means through the body e.g. Hull penetrations or Through-the-Hull Data Transfer.

The distortable surface is configured to be generally conformable to a shape of at least a part of the device. For example, by conforming the distortable surface to the curvature of a nosecone of an underwater vehicle, this may reduce drag and enhance the vehicle's streamline. The external surfaces of the sensor, not least any exposed outer walls of the housing and distortable surface, may be shaped to confer minimum drag via geometry, surface texture or by blending with a larger body to which the sensor is attached, e.g. a device/sub-sea vehicle.

Sensors in accordance with the present disclosure may provide a nature inspired (bio-inspired) system which seek to artificially emulate the bio-mechanical facial structures common to pinnipeds (like seals and sea lions) and rodents; namely a mystacial pad and set of whiskers of such animals. The distortable surface and vibrissae of sensors of examples of the disclosure can be analogous to such a mystacial pad and set of whiskers.

In some examples, each vibrissa (slender beam) can individually enable collection of flow, touch or vibrational data. The vibrissae are arranged in a mechanical structure which allows an inference of a complete array position/orientation by computational methods in a mechanically and computationally efficient manner.

Sensors in accordance with the present disclosure can allow the analysis of a change in a vibrissae array over time to allow flow sensing (such as detection and analysis of a wake in a fluid from a moving or static body in a flow-not least by Pair-Wise Correlation of slender beams using computing inference methodologies, e.g. machine learning trained algorithms/artificial neural networks/neuromorphic computing methods). Sensors can therefore allow wake homing as well as tracking and following of objects moving in a fluid by turning when internal features or edges of a wake are detected.

Sensors in accordance with the present disclosure can have lower energy usage than typically found in alternative sensors, such as sonar, and may have superior performance than some sonar systems when in close proximity to objects or terrain.

In some examples, the sensor may be used in any fluid medium (water, oil, air) and/or used as a haptic (tactile/touch) sensor if the vibrissae array is in range to either physically touch objects or encounter a pressure variation due to close proximity to an object.

One possible embodiment of the sensor would be in the form a module capable of insertion into/attachment onto a nose of a tubular unmanned underwater vehicle (UUV). A laterally symmetrically pair of sensors could be provided (e.g. on opposite sides of the nose) with data feed to the same processing system, e.g. fed into a feed forward Artificial Neural Network (ANN) for interpretation.

In some examples, the vibrissae (slender beams) form a sensor detection array, with each vibrissa connected by its respective root to an artificial mystacial pad capable of mechanical deformation (i.e. the distortable surface) as a means to detect movement of the vibrissae, and/or reconfigure the individual vibrissae relative to one another or a sensor housing, and/or to an aggregate arrangement of beams to the sensor housing.

In some examples, the sensor may be used on moving vehicles or robotics. The sensor would typically be placed in a forward position, so an incoming fluid medium is not adversely disrupted by the body, hull, fuselage, appendages or propulsion system of the vehicle.

In some examples, the distortable surface (artificial mystacial pad) could be configured to be easily/user removed and replaced if damaged, or swapped for a distortable surface having a different configuration of vibrissae and/or having vibrissae of differing attributes or materials—i.e. so as to be optimised for sensing flow/objects of differing categories, types, sizes or velocities. In some examples, the vibrissae could be configured to be easily/user removed and replaced if damaged, or swapped for vibrissae having differing attributes or materials—i.e. so as to be optimised for sensing flow/objects of differing categories, types, sizes or velocities.

In some examples, the distortable surface (artificial mystacial) pad may be partly or fully manufactured from a flexible material (soft robotic), or it may be articulated, to allow its deformation.

In some examples, the sensor could be used for wall proximity detection in fluids, such as proximity to structures or a seabed in underwater environments. This could allow general purpose collision avoidance and aid underwater navigation via improved underwater mapping and positional awareness, particularly in low visibility conditions (e.g. due to sediment).

In some examples, the sensor could be used as a static sensor, for example on a moored buoy, to detect a wake from: divers, surface vessels or underwater vehicles. A plurality of such static emplacements could be provided and arranged to form a line or grid to survey channels, entrances to ports, aquatic animal migrations routes, shipping lanes or used in a similar manner to towed array sonar systems.

In some examples, the sensor could be designed to have radial, hemispherical or omni-directional sensing, for example by having a radially or spherically symmetrical array of whiskers, or multiple sensor units affixed radially or spherically, for example for use on a buoy, probe, nose cone or line arrays.

In some examples, a sensor unit/housing of the sensor could be designed to conform to panel/tile/module dimensions or be integrated into panel/tile/modules, to allow retrofitting into surface cover systems, for example submarine anechoic hull tile systems.

In some examples, the sensor could be positioned on a surface structure downstream of a flow generated along the structure's surface, for example at the rear of a surface vessel hull or submersible hull for detection and identification of items on or near the surface structure (such as defects, damage, distortion, penetrations, missing tiles, foreign objects, bio-fouling, aquatic animals or divers disturbing the expected flow generated by the surface structure). An application of this type may include machine learning using training data of expected flow conditions and/or flow, turbulence or wake generated by particular items touching or proximate to the surface structure flow boundary layer.

In some examples, the sensor could be suitable to be used as a payload on glider type UUVs, for the purpose of long duration missions of submarine surveillance or marine animal, identification and convert following. The sensor could be used for torpedo wake homing.

In some examples, the sensor could be suitable for use on probes or unmanned systems dropped from the air (such as by a sonobuoy dispenser) or used in a similar manner to dipping sonar (on a cable from a hovering air vehicle), for example, for anti-submarine warfare (ASW) as detector of submarines. This would include use on cross-domain manoeuvre platforms (unmanned systems capable of gliding or powered flight in air and landing on, or submerging into, water). For example, a subsea glider designed to glide in air for a period after being dropped from an aircraft or ballistically launched from a tube having pop-out, variable sweep or folding/morphing wings.

In some examples, the sensor could be used for Mine Counter Measure (MCM) UUVs by detection and identification submerged objects in a flow by their wake using machine learning, and doing SO passively, without requiring acoustic or optical emission/transmission-which may trigger a mine or disclose the attempt to detect it.

FIGS. 5A to 5D schematically illustrate differing example configurations of a sensor (in this instance a sensor module comprising: an array of vibrissae 501 attached to and supported by a distortable surface 502, distortions of which are measured by distortion measuring means 503, wherein the distortion measuring means are provided within a sensor housing 509) which is provided on a nose cone of a submersible device 508.

FIG. 5A schematically shows the sensor in a deployed configuration/mode, wherein the vibrissae extend perpendicularly to the default/normal shape of the distortable surface 502, in such a manner, the vibrissae are extending to their maximal extent (as compared to the retracted/stowed configuration/mode of FIG. 5C). The distortion measuring means 503 comprises, in this example, a camera and mirror configured to view the inside surface of the distortable surface 502 which serves as a support structure to the vibrissae attached thereto.

FIG. 5B schematically shows the distortable surface 502′ in an extended configuration/mode, wherein the distortable surface 502 has been inflated thereby altering the shape and curvature of the distortable surface and consequently altering the position and orientation of the vibrissae 502′ attached to the distortable surface. In the example shown, the inflation of the distortable surface 502′ bends the surface causing the vibrissae 501′ to splay in a longitudinal direction (i.e. a longitudinal direction defined by the submersible device).

FIG. 5C schematically shows the distortable surface 502″ in a fully retracted/fully stowed configuration/mode, wherein distortable surface 502″ is adjusted so as to move the vibrissae 502″ attached thereto so as to lie substantially flat/parallel to the body of the submersible device. Such a fully retracted (pre-deployment or low drag) configuration can be achieved by inflation of specific chambers of a multi-chamber support structure, or via mechanical actuation (such as pulling on control wires at an end of each of the vibrissae to cause each vibrissa to rotate/pivot so as to lie substantially flat.

FIG. 5D schematically shows ‘dynamic whisking’ (i.e. actively moving vibrissae from protraction to retraction, including bilateral asymmetry with a paired sensor, and non-uniform position of each vibrissa). This could be achieved by variably inflating a set of chambers in the distortable surface. Such dynamic movement of the vibrissae during sensor measurement (e.g. dynamic rotation by collective or individual adjustment to one or more vibrissa shaft angle to produce a desired range of configurations of shaft rotations) may enable optimum sensing of fluidic flows, such as at differing velocities.

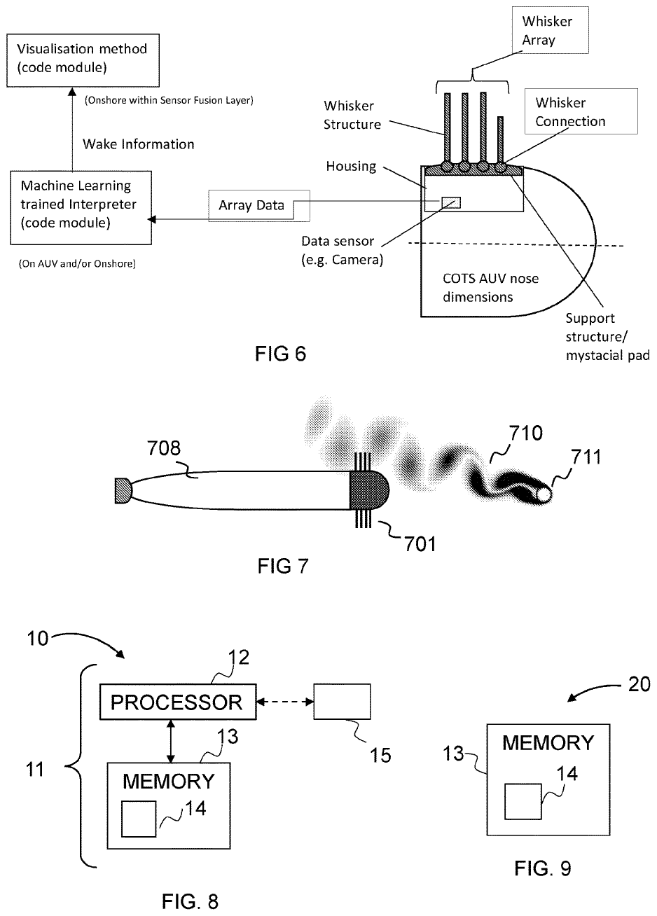

FIG. 6 schematically illustrates a sensor system. The system comprises a sensor module comprising: an array of whisker structures connected to a support structure/mystacial pad that forms an exterior surface of a housing of the sensor module. The sensor module is provided on a nose cone of a Commercial Off The Shelf (COTS) Autonomous Underwater Vehicle (AUV). Array data, indicative of the shape of the mystacial pad and/or representative of movement of the whisker array, captured by the data sensor is applied to a machine learning trained interpreter to determine wake information (such array data processing and interpretation computation could be done in the AUV itself, or remotely at an onshore data processing device). The wake information could be visualised and fused with other sensor data from other sensors (not shown). Such visualisation may occur at an onshore data processing and visualisation device).

A similar sensor module to that shown, with equivalent data processing, could be provided on the opposite side of the AUV.

FIG. 7 schematically illustrates an Autonomous Underwater Vehicle (AUV) comprising two sensor modules, one on each side of the AUV's nose cone, for detecting and measuring a wake 710 of an object 711. Differing wakes and wake patterns could be associated with differing objects and characteristics of objects that generate such a wake/wake pattern.

The sensor can be used for the detection, identification and tracking of fluidic wakes generated from fluid flow around an object or an object moving in a fluid, by the cross coalition of movement of the vibrissae. Sensor measurement data can be processed by a neural network and/or machine learning algorithms to infer position and velocity relative to the sensor and other attributes of the object in a fluid causing perturbation in the fluid.

By detecting and measuring characteristics of the wake, one could identify, recognise and determine characteristics of the object that generated the wake, not least for example determine a type of object that generated the wake (e.g. whether it was produced by: an animal, surface vessel, underwater vessel . . . ) as well as characteristics of the object (e.g. heading, size, speed . . . ).

Various examples of the disclosure have been described with reference to the use of shaft members (e.g. vibrissae) that are movably attached to a distortable surface. However, in some examples, no shaft members/vibrissae are used. In some examples, there is provided a sensor for sensing fluid flow, touch and/or vibration, the sensor comprising: a plurality of distortable external surfaces; and means configured to measure distortion of one or more of the plurality of distortable surfaces. In some examples, a plurality of flexible pads defines the distortable surface, wherein in use the flexible pads are in direct contact with a fluid flow to be detected/measured (rather than behind a cover). In some examples, a plurality of highly sensitive pressure pads are used instead of shaft members/vibrissae. Non-vibrissae-based sensors can be considered, in effect, as corresponding to vibrissae-based sensors having zero length vibrissae/shaft members. As with the vibrissae-based sensor, in the non-vibrissae-based sensors/pad-based sensors, distortions of the distortable surface are sensed at a base area of where a vibrissa would have been (i.e. where a pad is instead). For example, vibrissae could be replaced with a flexible circular membrane, e.g. within a nose cone, in an array (such as a mystacial pad pattern). Also, the flexible circular membranes could be tuned to vibrate more easily at different frequencies, i.e. so as to replicate vibrissae of differing lengths/types.

Various, but not necessarily all, examples of the present disclosure can take the form of an apparatus, a method or a computer program. Accordingly, various, but not necessarily all, examples can be implemented in hardware, software or a combination of hardware and software.

Various, but not necessarily all, examples of the present disclosure provide both a method and corresponding apparatus comprising various modules, means or circuitry that provide the functionality for performing/applying the actions of the method. The modules, means or circuitry can be implemented as hardware (e.g. special purpose hardware), or can be implemented as software or firmware to be performed by a computer processor. In the case of firmware or software, examples of the present disclosure can be provided as a computer program product including a computer readable storage structure embodying computer program instructions (i.e., the software or firmware) thereon for performing by the computer processor.

FIG. 9 schematically illustrates a block diagram of an apparatus 10 for performing the methods, and functionality described in the present disclosure and illustrated not least in FIG. 2.

The apparatus 10 comprises a controller 11, which could be provided within a device such as, not least an underwater vehicle or device.

The controller 11 can be embodied by a computing device. In some, but not necessarily all examples, the apparatus can be embodied as a chip, chip set, circuitry or module. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc, to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: the means for measuring distortions of the distortable surface, a radio transceiver e.g. for transmitting distortion measurements/sensor measurement data, and/or other modules/devices/components for inputting and outputting data/commands).

The memory 13 stores a computer program 14 comprising computer program instructions (computer program code) that controls the operation of the apparatus 10 when loaded into the processor 12. The computer program instructions, of the computer program 14, provide the logic and routines that enables the apparatus to perform the methods, processes and procedures described in the present disclosure and illustrated in FIG. 2. The processor 12 by reading the memory 13 is able to load and execute the computer program 14.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the functionality, methods, and processes described in the present disclosure and illustrated in FIG. 2. It is contemplated that the functions of these components can be combined in one or more components or performed by other components of equivalent functionality. The description of a function should additionally be considered to also disclose any means suitable for performing that function. Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

In one example, the apparatus is embodied on an underwater device, an underwater vehicle, an unmanned submersible vehicle; and a robotic arm.

In some examples, the apparatus comprises:
at least one processor 12; and
at least one memory 13 including computer program code the at least one memory 13 storing instructions that, when executed by the at least one processor 12, cause the apparatus at least to perform the methods, functionality and processes described in the present disclosure and illustrated in FIG. 2.

FIG. 9, illustrates a computer program 14 conveyed via a delivery mechanism 20. The delivery mechanism 20 can be any suitable delivery mechanism, for example, a machine readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided computer program instructions for causing an apparatus 10 to perform the methods, functionality, and processes described in the present disclosure and illustrated in FIG. 2.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Although specific terms are employed herein, they are used in a generic and descriptive sense only and not for purposes of limitation. Features described in the preceding description can be used in combinations other than the combinations explicitly described. Although functions have been described with reference to certain features, those functions can be performable by other features whether described or not. Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent. Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘attach’, ‘connect’, ‘couple’ and their derivatives mean operationally attached/connected/coupled. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining (for example via use of a trained machine learning model)) and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described. In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1-27. (canceled)

28. A sensor for sensing fluid flow, touch and/or vibration, the sensor comprising:
a plurality of elongate shaft members movably attached to a distortable surface such that movement of one or more of the plurality of elongate shaft members distorts the surface;
a distortion measurement device configured to measure distortion of the distortable surface for determining movement of one or more of the plurality of elongate shaft members, wherein the distortion measurement device comprises at least one image capturing device configured to capture an image of the distortable surface, and wherein a distortion of the distortable surface is measured based at least in part on the captured image of the distortable surface; and
a movement device configured to move one or more of the plurality of elongate shaft members relative to the distortable surface or relative to another of the plurality of elongate shaft members.

29. The sensor of claim 28, wherein the distortion measurement device is further configured to input the captured image of the distortable surface into a model, wherein the model is configured to receive, as an input, an image of the distortable surface and output an indication of a measurement of a distortion of the distortable surface.

30. The sensor of claim 28, wherein the distortable surface comprises one or more fiducial markers.

31. The sensor of claim 28, wherein the captured image of the distortable surface comprises a captured image of an interior side of the distortable surface.

32. The sensor of claim 28, wherein the plurality of elongate shaft members comprises elongate shaft members having differing lengths and/or differing resonant frequencies.

33. The sensor of claim 28, wherein one or more of the plurality of elongate shaft members are configured to be able to: convey light therethrough, and modulate light conveyed therethrough responsive to the one or more of the plurality of elongate shaft members being bent.

34. The sensor of claim 28, wherein the sensor is further configured to sense electromagnetic radiation.

35. The sensor of claim 28, wherein the movement device comprises one or more of:
a position controlling device configured to control a position of one or more of the plurality of elongate shaft members relative to the distortable surface or relative to another of the plurality of elongate shaft members;
an angle adjusting device configured to adjust an angle at which the one or more of the plurality of elongate shaft members extend from the distortable surface;
a retracting device configured to retract the one or more of the plurality of elongate shaft members;
a deploying device configured to deploy the one or more of the plurality of elongate shaft members.
a shape adjustment device configured to adjust a shape of the distortable surface;
a deforming device configured to deform the distortable surface;
at least one expandable chamber; and
one or more individually expandable chambers disposed adjacent a proximal end of one or more of the plurality of elongate shaft members.

36. The sensor of claim 28, further comprising at least one rigid protruding member, disposed proximal to the one or more elongate shaft members, wherein the at least one protruding member is fixed to the sensor such that the at least one protruding member is substantively immovable with respect to the sensor and/or distortable surface.

37. The sensor of claim 28, wherein the sensor comprises at least a two-dimensional array of elongate shaft members.

38. The sensor of claim 37, wherein the movement device is configured to move the one or more of elongate shaft members in one or more dimensions of the at least two-dimensional array of elongate shaft members.

39. The sensor of claim 28, wherein the sensor is configured to be submersible.

40. A device comprising the sensor of claim 28, wherein the device is one or more of:
an underwater vehicle;
an autonomous underwater vehicle;
an unmanned submersible vehicle; and
a robotic arm.

41. The device of claim 40, wherein the distortable surface is conformable to a shape of at least a part of the device.

42. A system comprising the sensor of claim 28, the system further comprising:
at least one processor; and
at least one memory including computer program code;
the at least one memory storing instructions that, when executed by the at least one processor, cause the apparatus at least to:
determine movement of one or more of the elongate shaft members based, at least in part, on one or more measurements, from the means configured to measure a distortion of the distortable surface, of deformation of the deformable surface;
measure fluid flow and/or vibration based, at least in part, on one or more measurements, from the means configured to measure distortion of the distortable surface, of deformation of the deformable surface;
detect an object via tactile sensing based, at least in part, on one or more measurements of deformation of the deformable surface;
detect and measure a wake of an object based at least in part on one or more measurements of deformation of the deformable surface due to the wake; and
identify an object via a wake of the object based at least in part on one or more measurements of deformation of the deformable surface due to the wake.

43. A method comprising:
measuring distortion of a distortable surface of a sensor, wherein a plurality of elongate shaft members is movably attached to the distortable surface such that movement of one or more of the plurality of elongate shaft members distorts the distortable surface, and wherein a distortion of the distortable surface is measured based at least in part on a captured image of the distortable surface;
determining movement of one or more of the plurality of elongate shaft members based at least in part on the measured distortion of the distortable surface; and
moving one or more of the plurality of elongate shaft members relative to the distortable surface or relative to another of the plurality of elongate shaft members.

44. The method of claim 43, further comprising generating sensor measurement data based at least in part on inputting data indicative of the measured distortion of the distortable surface into a model, wherein the model is configured to receive, as an input, one or more measurements of distortions of the distortable surface and output sensor measurement data for the same.

45. The method of claim 44, wherein:
the model is configured to correlate and/or perform a mapping of the measurements of distortions of the distortable surface to sensor measurement data; and/or
the model is generated via a machine learning system that has been trained, on a training dataset comprising a plurality of measurements of distortions of the distortable surface whose respective sensor measurement data have been pre-determined, so as to determine one or more correlations between distortions of the distortable surface and sensor measurement data.

46. The method of claim 44, wherein the sensor measurement data is indicative of a measurement or detection of at least one of:
movement of one or more of the plurality of elongate shaft members, a fluid flow,
a touch,
a vibration,
a wake, and/or
an object.

47. An apparatus comprising:
at least one processor; and
at least one memory including computer program code;
the at least one memory storing instructions that, when executed by the at least one processor, cause the apparatus at least to carry out the method of claim 43.
